(19) United States
(12) Patent Application Publication
(10) Pub. No.: US 2018/0157731 A1
(43) Pub. Date: Jun. 7, 2018

(54) HIERARCHY MEMBER SELECTIONS IN QUERIES BASED ON RELATIONAL DATABASES

(71) Applicant: Business Objects Software Ltd., Walldorf (DE)

(72) Inventor: Olivier Tsoungui, Viry Chatillon (FR)

(21) Appl. No.: 15/368,719

(22) Filed: Dec. 5, 2016

(51) Int. Cl. G06F 17/30

(52) U.S. Cl. CPC G06F 17/30592; G06F 17/30241; G06F 17/30607

(57) ABSTRACT

A universe is created on top of a relational database. The relational database includes database tables with attributes to describe objects. The universe includes objects corresponding to attributes of database objects. Creating the universe on top of the relational database may include creating of a connection to the relational DB to define a data foundation for creating the universe. A hierarchy object is created as part of the universe. A hierarchy type for the hierarchy object is defined. The hierarchy object defines a hierarchy of dimension objects from the universe. An exemplary hierarchy object may be of a level-based hierarchy type or of a parent-child hierarchy type. The universe is saved to include the hierarchy object. The universe is published into a repository. The published universe serves requests to generate queries and to run reports based on data from the relational database.

### FIELD

The field generally relates to data processing and database systems.

### BACKGROUND

Enterprise data is generated at a high speed mostly through transactional systems used by companies. Organizations can gain business value by exploring and analyzing transactional data, which may be generated within the enterprise or from other raw data of internal or external sources (e.g. social media). Business entities may utilize database offering to store big data. Such data may have little meaning without appropriate data analysis. Some business entities may utilize platforms that include databases to handle big data and to perform real time analyses. Such platforms may involve advanced processing features, e.g., of both the platforms and the associated databases. At the databases, object instances may be stored. The object instances may be created based on a data model, including definitions of attributes of the objects. Object instances may be organized in a hierarchical manner according to hierarchy criteria, such as location, time, enterprise organization, etc.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with their advantages, may be best understood from the following detailed description taken in conjunction with the accompanying drawings.

FIG. 1 is a block diagram illustrating an exemplary system supporting hierarchy member selections in queries based on relational databases, according to one embodiment.

FIG. 2 is a flow diagram illustrating a process for supporting hierarchy member selections in queries based on relational databases, according to one embodiment.

FIG. 3 is a block diagram illustrating a system providing functionality to support hierarchy member selections in queries based on relational databases, according to one embodiment.

FIG. 4 is a block diagram illustrating exemplary user interface of an information design tool for defining level-based hierarchy objects on top of a universe defined for relational databases, according to one embodiment.

FIG. 5 is a block diagram illustrating exemplary user interface of an information design tool for defining parent-child hierarchy objects on top of a universe defined for relational databases, according to one embodiment.

FIGS. 6A, 6B, 6C, 6D, 6E, and 6F are block diagrams illustrating exemplary queries defined for universes comprising defined hierarchy objects, according to one embodiment.

FIG. 7 is a block diagram illustrating an embodiment of a computing environment in which the techniques described for providing support for hierarchy member selections in queries based on relational databases, can be implemented.

### DETAILED DESCRIPTION

Embodiments of techniques for providing support for hierarchy member selections in queries based on relational databases are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In one embodiment, a semantic layer may be created to reside between a database storing enterprise data and an end user. The semantic layer may be created to provide a representation of data stored in the database. The semantic layer may be represented as a universe, supporting the user to interact with the stored data in the database, without having to know the complexities of the database or where the data is stored. The universe may facilitate the retrieval of data of interest by the user. A universe may be generated for a data source including a multi-dimensional array of data, such as an Online Analytical Processing (OLAP) cube, or from a query. In this case, the universe may be created automatically from a selected connection to a data source. A universe may be also created by selecting multiple tables and columns from various relational data sources. Once the universe is created, it can be exported to a repository and may be available for user requests to run queries or to create reports.

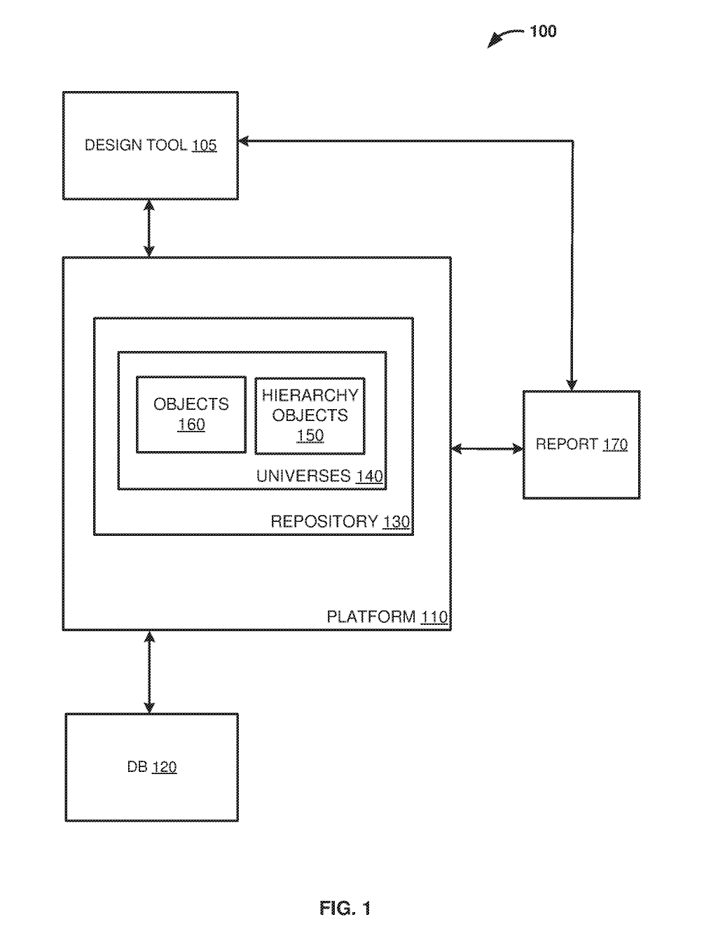

FIG. 1 is a block diagram illustrating an exemplary system 100 supporting hierarchy member selections in queries based on relational databases, according to one embodiment. Platform 110 may be coupled to database (DB) 120. The platform 110 may be a business objects platform for creating business objects for an enterprise, based on consumption of data from connected data sources. The platform 110 may provide services and infrastructure for generating analytics reports. The DB 120 may be a relational database and a connection between the platform 110 and the DB 120 may be established. The DB 120 may store data objects. The data objects may be defined with attributes, such as dimensions, measures and others business entities. The data stored at a DB may comprise flat and/or hierarchical data. The platform 110 includes repository 130 including universes 140.

In one embodiment, relational databases, such as Structured Query Language (SQL) databases, are used by customers to generate reports and to perform data analysis. Some relational databases do not support hierarchy metadata for stored object instances that can be created in a standardized and/or non-database specific manner. A universe from the universes 140 may be created by selecting a data source connection to the DB 120. The DB 120 may be a relational database that do not support hierarchy metadata related to stored object instances. The universe creation process may be automated and started once the connection is selected. This universe creation process may be also started after selecting tables and columns from the relational data source. The structure of the connected data source is mapped to objects from the universe. For example, the universe may include objects defining classes, measures, dimensions, details, etc. The universe structure may be accessed through the design tool 105. The design tool 105 may provide a user interface (UI) including a universe pane. Once a universe is created, the universe may be modified, for example, through the UI of the design tool 105.

In one embodiment, during an activity of analyzing a data set from the DB 120, different aspects with regards to columns in a data set may be taken into account. Classifications of the columns of the database tables in the DB 120 may be determined. For example, the classifications may be related to a data type, an analysis type, an aggregation type, a format, a category, a hierarchy, etc., of the data stored in a column. The columns in the database tables may be defined as attributes of the data objects. Data for data object instances are stored in the database tables of the DB 120. An attribute (e.g. a column) may be classified as a measure or a dimension.

In one embodiment, columns that include qualitative data may be classified as dimensions, and columns that include quantitative or numeric data may be classified as measures For example, when a column includes data related to an amount of money, for example, for received month revenue, then the column may be classified as a measure. In another example, when a column includes data related to a geographical location. e.g. France, then the column may be classified as a dimension. If a column qualifies as a measure, an appropriate aggregation type may be determined. If a column is classified as a dimension, the column may be categorized, e.g. in a geographical or time category. A logical correlation for geographical and time categorized columns may be determined and different hierarchies may be defined. The classification of the columns in the data set may be stored as metadata entries in a corresponding database schema. The data stored in the DB 120 may include hierarchical data for data objects.

The universes 140 represent a dimensional semantic layer that resides between an organization's database, such as the DB 120, and an end user, who performs analysis and interacts with the data residing in the DB 120. A universe from the universes 140 may be created as a business representation of a data warehouse or a transactional database. The definition of universes 140 allows users to interact with data without having to know the complexities of the underlying database or where the data are stored. The universes 140 may be created using familiar to the user business terminology to describe a business environment of an enterprise working with data from the DB 120. A universe of the universes 140 may be created in relation to the connection to the DB 120. A universe may include a definition of a connection parameter to a data structure, such as the DB 120. The universes 140 include objects 160 that map to actual data structures in correspondingly connected databases. The objects 160 may be grouped into classes and subclasses. A universe from the universes 140 may include a schema of tables and joins from the corresponding DB (e.g., DB 120). The objects 160 in the universe may be built based on tables that are included in the schema.

Hierarchies may be detected in relation to dimensions such as time and geographical dimensions. For example, a dimension storing year values and a dimension storing month values may be determined to be part of one hierarchy, where “year” is at a higher level than “month” level. The universes 140 may be modified to include hierarchy characteristics of data from the correspondingly associated database connections. For example, hierarchies for the different dimensions of objects may be detected from a DB such as DB 120. Based on a definition of such hierarchies, hierarchy objects 150 may be generated correspondingly for the universes 140. The creation of the hierarchy objects 150 may be performed through the design tool 105. After the hierarchy objects 150 are generated, they may be stored in corresponding universes in the repository 130. In such a manner, a hierarchy object is created inside a relational universe without adding new metadata at database level. When the hierarchy objects 150 are published in the repository 130 as part of the universes 140, the hierarchy objects 150 may be used for querying data from corresponding databases, such as DB 120, and provide a report (e.g., report 170) as a result. The report 170 may be generated through a query, created within the design tool 105, or from a Business Intelligence (BI) tool for generating reports. The universes 140 including hierarchy objects 150 define a dimensional semantic layer that integrates the concept of storing multi-dimensional data with the concept of hierarchical organization inside universes.

When generating a report, such as report 170, the information for the universes 140 may be consumed by the design tool 105, or by other business intelligence tools for generating reports. Through the design tool 105, hierarchical reports may be generated as outputs based on universes 140, which include hierarchy objects 150. For example, reports with fold and unfold capabilities that support expanding or hiding sections of a report without having to drill down. For example, the generated reports may include level totals, hierarchical columns and graphics, hierarchical formulas, etc. Such reports may facilitate better data analysis on datasets with drill-through capabilities supporting opening a report by clicking a link within another report, and/or navigating through multi-dimensional data. The report 170 may be generated by running powerful hierarchical queries including member selections. The generated hierarchical queries may be based on the provided hierarchy objects 150 in the universes 140.

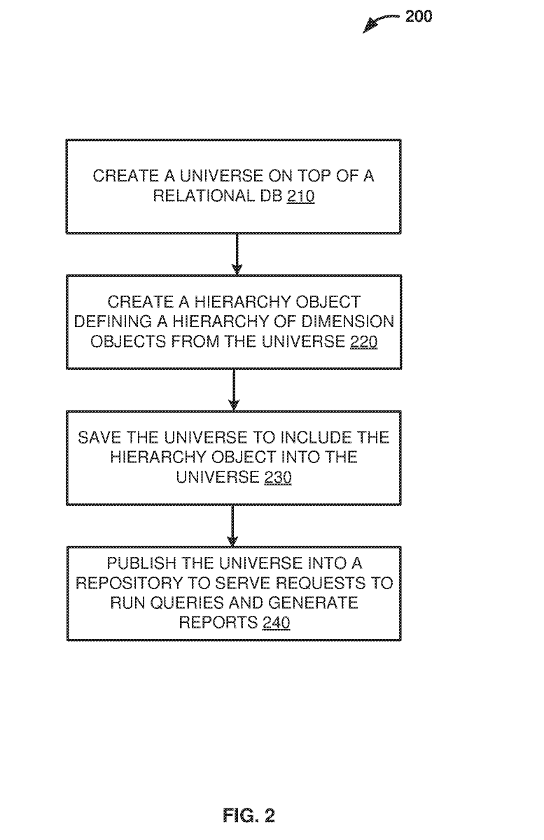

FIG. 2 is a flow diagram illustrating a process 200 for supporting hierarchy member selections in queries based on relational databases, according to one embodiment. At 210, a universe is created on top of a relational DB. The universe may be such as a universe from the universes 140, FIG. 1. The relational DB, may be such as the DB 120, FIG. 1. The relational DB may include database tables with attribute columns to describe the objects. The relational DB may be associated with a data structure and described in a database schema. The universe may include objects corresponding to attributes from the database. The objects in the universe may be of different types, for example, measures, dimensions, details, other. Creating the universe on top of the relational database may include creating of a connection to the relational DB to define a data foundation for creating the universe. The data foundation is the description of the database schema of the connected relational DB. The database schema includes tables, columns, keys, joins, etc. The creation of the universe may also include a definition of a business object layer. Within the business object layer, attributes of database objects corresponding to dimensions are defined as objects included in the universe definition. The universe may be created in an information design tool, such as the design tool 105, FIG. 1. In the information design tool, a new hierarchy object may be created as part of the business object layer. A hierarchy type for the new hierarchy object may be defined. In the information design tool, a set of objects defined as dimensions in the universe are associated with hierarchy levels in the new hierarchy object.

At 220, a hierarchy object is created. The hierarchy object defines a hierarchy of objects from the universe. The hierarchy object may be such as the hierarchy objects 150, FIG. 1. An exemplary hierarchy object may be of a level-based hierarchy type or of a parent-child hierarchy type. For example, a hierarchy may be defined between objects that represent geographical locations (e.g. country>city>street) or between objects that represent time values (e.g. year>month>date>time). At 230, an updated universe is saved to include the hierarchy object. The updated universe is published into a repository at 240. The repository where the updated universe is published may be such as the repository 130 from a platform, such as a business objects platform. The published updated universe serves requests to run queries and to generate reports based on data from the connected relational DB.

In one embodiment, a request to provide the updated universe from the repository to the information design tool may be received. The request may be provided by a user, requesting to generate a report, such as the report 170, FIG. 1. The report that may be generated may include hierarchy member selections based on the defined hierarchy objects in the updated universe. A query based on the updated universe is defined to generate the report. The report may be defined in relation to a number of hierarchy objects. The defined query may be run in the relation DB associated with the universe. When the query is executed, a data set from the relational database is retrieved.

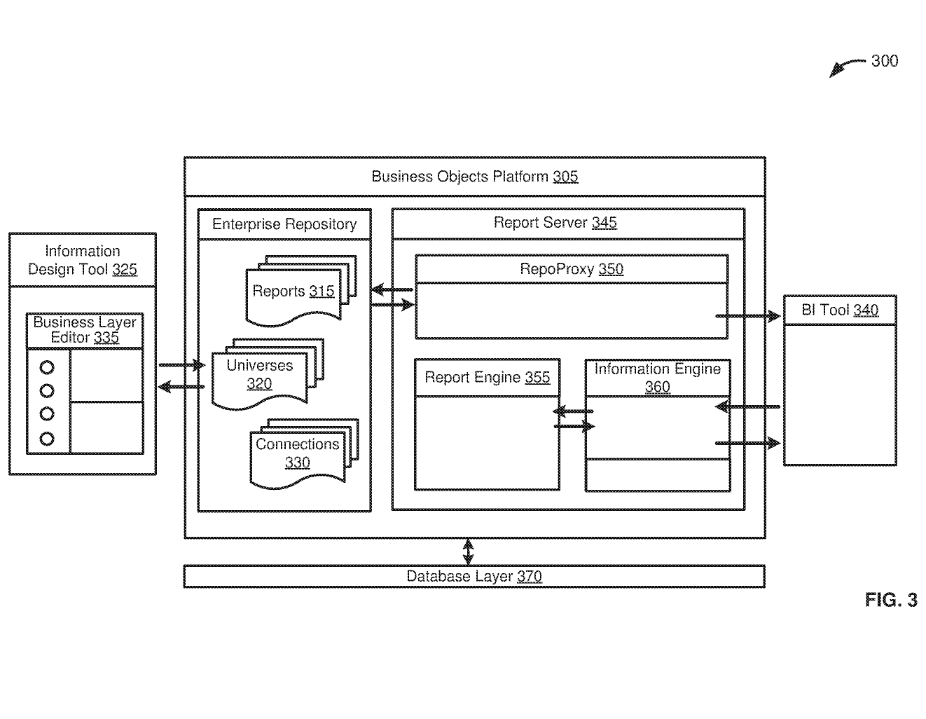

FIG. 3 is a block diagram illustrating a system 300 providing functionality to support hierarchy member selections in queries based on relational databases, according to one embodiment. A business objects platform (BOP) 305 is instantiated for storing information for business objects and providing services, infrastructure, and data for performing analysis over information associated with enterprises, which data is stored at databases in a database layer 370. The database layer 370 includes databases of different types, for example relational databases, OLAP databases, etc. The BOP 305 may correspond to the platform 110, FIG. 1. The BOP 305 includes an enterprise repository, where reports 315, universes 320, and connections 330 are stored. The universes 320 may be such as the universes 140, FIG. 1. The enterprise repository may be such as the repository 130, FIG. 1. The enterprise repository may be a content management system (CMS).

An information design tool 325 may be related to the BOP 305. Through the information design tool 325, universes 320 may be invoked, reviewed, and modified. The information design tool 325 may correspond to the design tool 105, FIG. 1. The information design tool 325 includes a business layer editor 335, which facilitates editing of semantic business definitions included in the universes 320. A user may interact with the business layer editor 335 to invoke a universe from the universes 320. The invoked universe may be loaded in the business layer editor 335 and different objects may be presented in a structural organization. The business layer editor 335 may provide functionality for changing universes from the universes 320. A universe from the universes 320, which is associated with a relational DB, may be amended to include a hierarchy objects for a hierarchy organization of objects defined in the universe. The universe may be amended as described in relation to FIG. 2. In the business layer editor 335, a user may browse a relational universe and create and insert new universe hierarchy objects. Such hierarchy objects may support providing of reports and data analysis in relation to hierarchy semantics of the data stored in the relational DB.

In one embodiment, a user may select a universe from the universes 320, and import it on a local storage through the information design tool 325. The selected universe is imported and a new hierarchy object may be created on top of the universe. The created new hierarchy object may be shared and published into the enterprise repository as part of the universe in the universes 320 section. Once it is published in the enterprise repository, the updated universe including the new hierarchy object becomes accessible for generating business intelligence (BI) reports through reporting tools associated with the BOP 305. The BOP 305 is associated with a BI tool 340, where reports may be created and queries for data may be generated. The reports requested through the BI tool 340 may be based on queries including universe hierarchy objects, as in the universes 320.

The BOP 305 includes a report server 345, which is an environment for running reports. The report server 345 includes a repo proxy 350, a report engine 355, and an information engine 360. The information engine 360 communicates with the BI tool 340 when a request for generating a report is received. The information engine 360 interacts with the report engine 355. The report engine 355 provides information associated with relevant data and columns associated with generated reports. The information engine 360 communicates with the universes 320 to receive information for relevant universes, as requested through the BI tool 340. The information engine 360 is an engine of the semantic business layer of the BOP 305 and defines queries, such as SQL queries. The defined queries in the information engine 360 may be executed on corresponding databases from the database layer 370. The information engine 360 is communicating with the universes 320 to receive universe definitions. The Information Engine 360 includes implemented logic to interpret universes including hierarchy objects, while generating queries including hierarchy member selections. At runtime, the queries defined in the BI tool 340 for requesting generation of reports may be transmitted to the information engine 360 and executed therein. Once the reports are executed and created, they may be communicated to the enterprise repository through the repo proxy 350. Generated reports may be stored in the reports 315 section of the enterprise repository.

In one embodiment, when a request for a report generation is received at the BI tool 340, there may be a correspondingly defined query in the BI tool 340. When the requested query includes hierarchy member selections based on hierarchy objects from a relevant universe, the information engine 360 may first load the relevant universe from the enterprise repository in order to get the definition of the universe hierarchy objects, and a data connection type to a data source related to the universe. According to a relational connection type, the Information Engine 360 may generate a native query script according to the query specification and the hierarchy member selections in the query. The native query script may be executed on the relevant data source (e.g. a DB) from the database layer 370 in order to retrieve query results data sets. Once the query result data set is retrieved from the data source, the data may be formatted according to user-predefined settings and may be returned to the client BI tool. A metadata definition for hierarchy objects associated with the query and the requested report may also be transmitted to the report engine 355 for defining reporting workflows. For example, such workflows may include a collapse or expand options, a fold and unfold options, a use of hierarchy formulas, other.

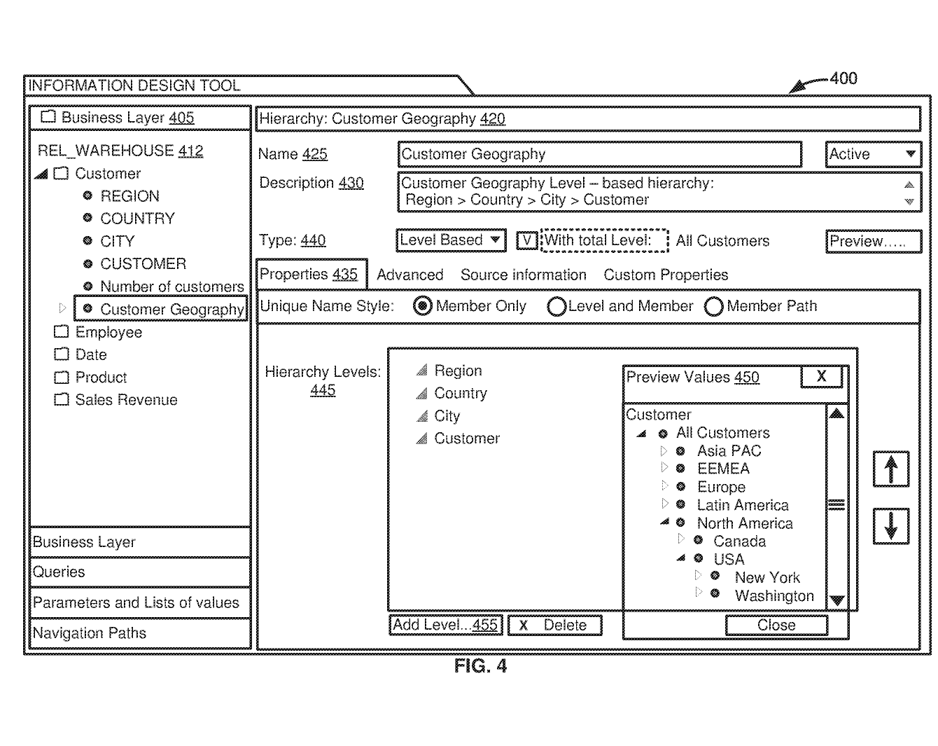

FIG. 4 is a block diagram illustrating exemplary UI 400 of an information design tool for defining level-based hierarchy objects on top of a universe defined for relational databases, according to one embodiment. The information design tool may be such as the information design tool 325. The UI 400 includes a business layer 405 pane, where a list of available universe objects may be displayed. For example, for a universe, named “REL_WAREHOUSE” 412, a number of universes objects may be displayed and organized in classes defined as folders, such as Customer, Employee. Date. Product, Sales Revenue. A hierarchy object is created through the UI 400 of the information design tool. The hierarchy object is created as a hierarchy object “Customer Geography” 420 under the class (folder) “Customer” on top of a universe “REL_WAREHOUSE” 412 associated with a relational DB. The class “Customer” includes objects such as REGION, COUNTRY, CITY, CUSTOMER, and Number of customers. The objects—REGION, COUNTRY, CITY, CUSTOMER as in the universe “REL_WAREHOUSE” are dimension objects. The “Number of customers” object is of a measure type. The hierarchy object is associated with a Name 425 field—“Customer Geography”, a Description 430 field—“Customer Geography Level-based hierarchy: Region>Country>City>Customer”, and information for the hierarchy object Type 440. The created “Customer Geography” 420 object is defined as a level-based type hierarchy object, where a number of hierarchy levels are order according to a sequence defined for a hierarchy. The created “Customer Geography” 420 object is stored as part of the universe “REL_WAREHOUSE” as presented in the business layer 405 pane. In the current “Customer Geography” 420 object the geography levels are such as Region, Country, City, and Customer. The levels in the hierarchy are based on dimension objects from the relevant universe. For example, region is a dimension attribute for a data object stored in the connected relational DB. However, other level of granularity may be introduced, for example, the levels may be region, city, and customer, without country. The type of the created “Customer Geography” 420 object is defined in the type 440 field—“Level Based”. For the type of the created “Customer Geography” 420 object, a type pane may be displayed, having a number of tabs, such as Properties, Advanced, Source information, Custom properties. For the Properties 435 tab, a unique name style may be defined through selection of an option from a list of options. On the UI 400, an option “Member only” is selected for the unique name style. For the Properties 435 tab, hierarchy levels 445 pane may be displayed, as for the “Customer Geography” 420 object. The UI 400 provides options for including more levels in the hierarchy through activating the “Add Level . . . ” 455 button. A preview values 450 display section may be included as part of the Hierarchy Levels 445 pane. The preview values 450 display selection provides a display of the organization of data from the data source, based on the hierarchy levels for the “Customer Geography” 420 object. The customers associated with the universe are located in regions such as Asia PAC, EEMEA, Europe, Latin America, North America. The preview values 450 may provide data, which may be invoked from metadata stored for the connected relational DB associated with the corresponding universe.

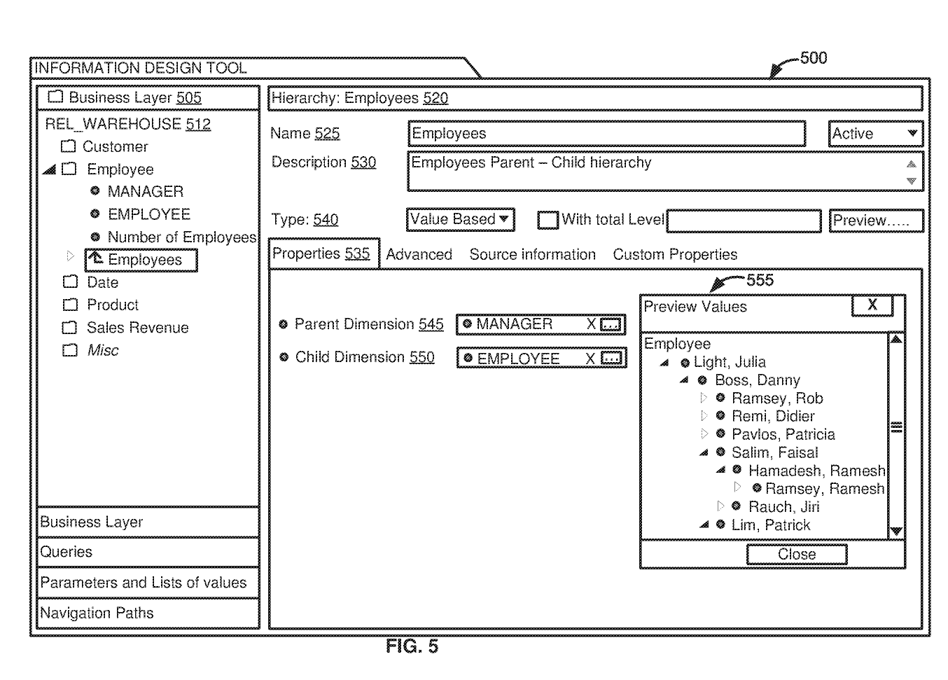

FIG. 5 is a block diagram illustrating exemplary user interface 500 of an information design tool for defining parent-child hierarchy objects on top of a universe defined for relational databases, according to one embodiment. The information design tool may be such as the information design tool 325. The UI 500 includes a business layer 505 pane, where a list of available universe objects may be displayed. For example, for a universe, named “REL_WAREHOUSE” 512, a number of universe objects may be displayed and organized in classes defined as folders in the business layer 505 pane, such as Customer, Employee, Date, Product, Sales Revenue. A hierarchy objects is created through the UI 500 of the information design tool. The hierarchy objects is created as an hierarchy object “Employees” 520 under the class “Employee” on top of a universe “REL_WAREHOUSE” associated with a relational DB. The class “Employee” includes objects such as Manager. Employee, and a Number of employees. The objects “Manager” and “Employee” in the universe “REL_WAREHOUSE” 512 are dimension objects. The “Number of Employees” object is a measure. The definition of the hierarchy object is associated with a name 525 field—“Employees”, a description 530 fields—“Employees Parent”, and with information for the hierarchy object type 540. The created “Employees” 520 object is defined as a parent-child type hierarchy object, where two dimensions are defined correspondingly for a parent dimension and a child dimension, defined for the hierarchy object. The created “Employees” 520 object is stored as part of the universe “Customer” as presented in the business layer 505 pane. The type of the created “Employees” 520 object is defined in the Type 540 field—“Value Based”. For the type of the created “Employees” 520 object, a type pane may be displayed, having a number of tabs, such as Properties, Advanced, Source information, Custom Properties. For the Properties 535 tab, hierarchy levels are Parent Dimension 545 and Child Dimension 550. The parent dimension is “Manager” and the Child Dimension 550 is “Employee”. A preview values 555 display section may be included as part of the properties 535 tab display section. The preview values 555 display selection provides a display of the organization of data from the data source, based on the defined hierarchy levels for the “Employee” 520 object. The employees identified by their names are represented in a tree structure, having a “manager-employee” relation. The preview values 555 may provide data, which may be invoked from metadata stored for the connected relational DB associated with the corresponding universe.

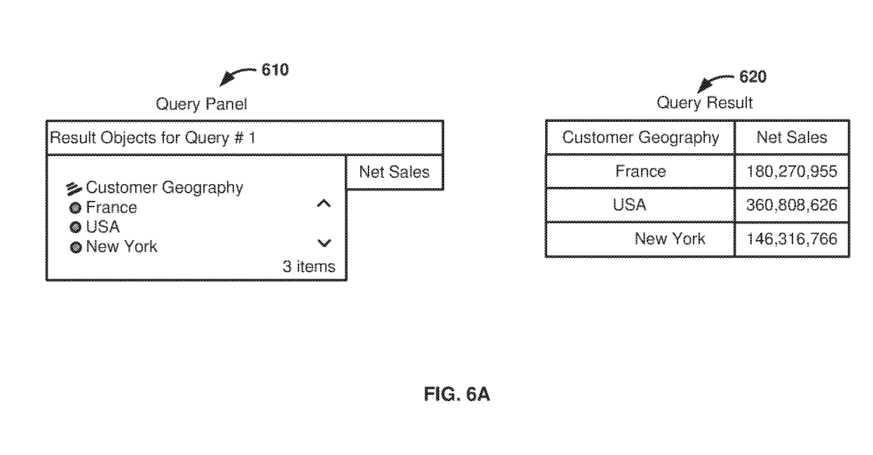

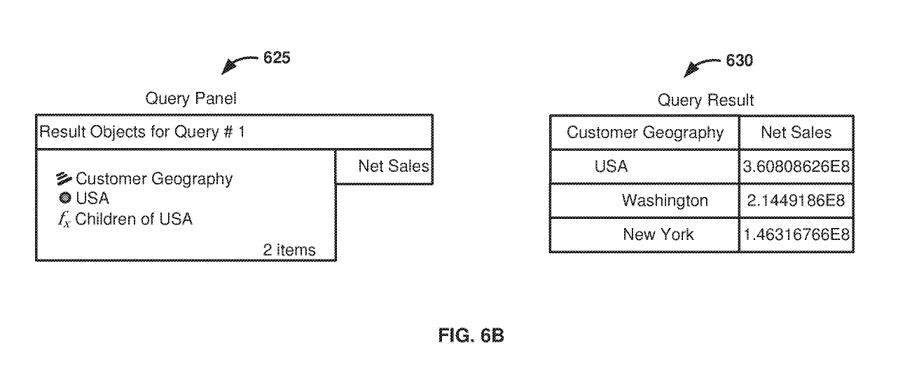

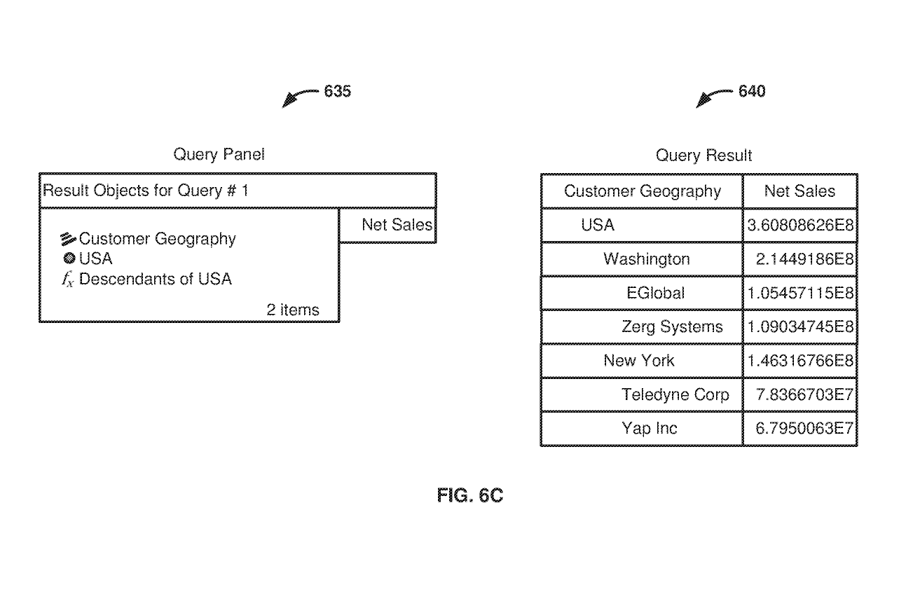

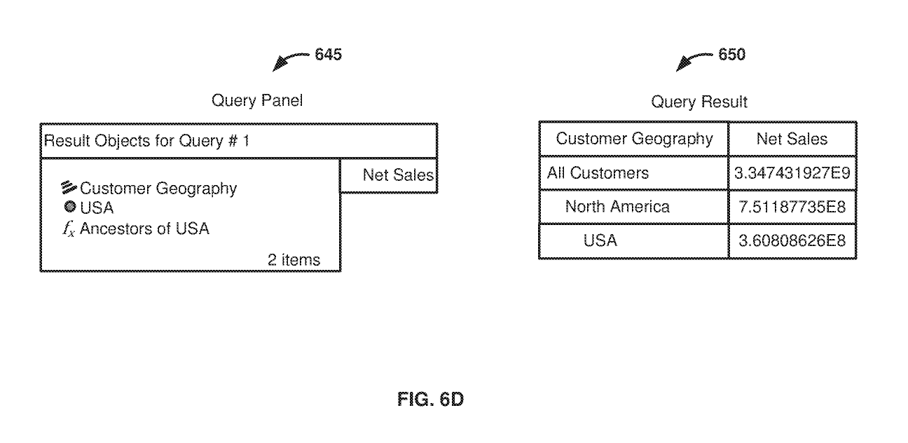

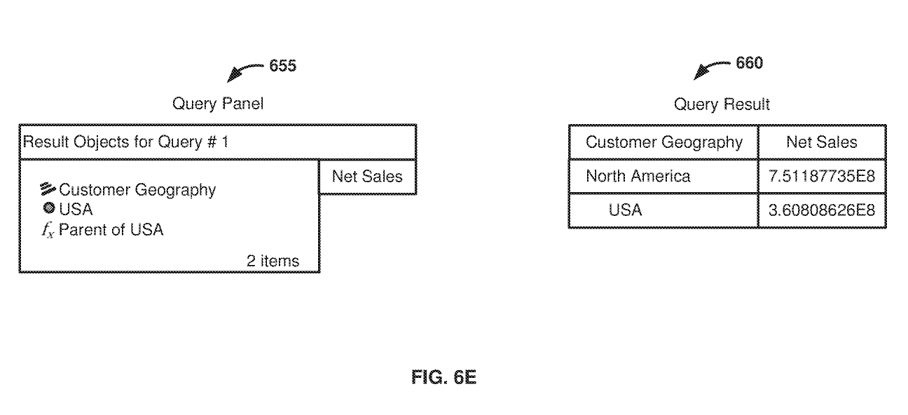

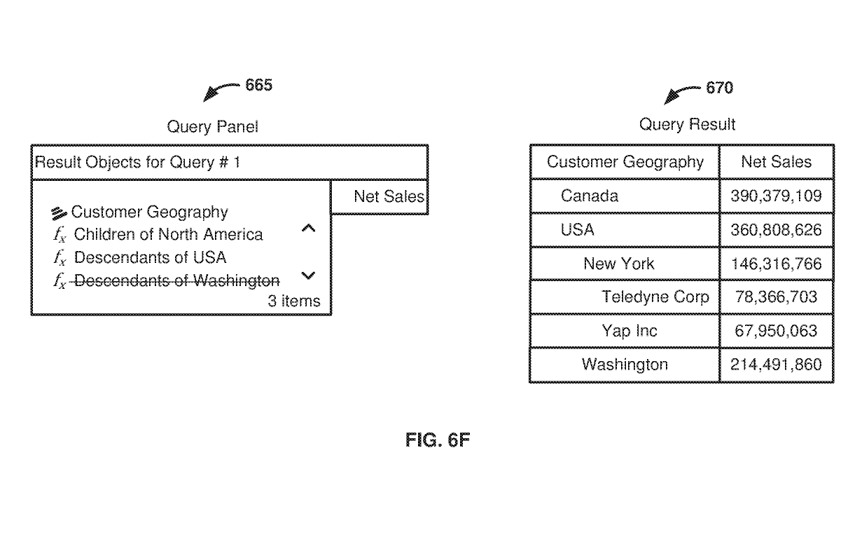

FIGS. 6A, 6B, 6C, 6D, 6E, and 6F are block diagrams illustrating exemplary queries defined for universes comprising defined hierarchy objects, according to one embodiment. In one embodiment, a query panel may be used to define queries associated with reports over data stored in relational DBs. The query panel may be provided from a BI tool, such as the BI tool 340, FIG. 3. A query associated data from a relation DB may be generated through the query panel and may be based on hierarchy member selections, where hierarchy objects are associated correspondingly with universes for the relational DB. The query may be defined through the query panel, where selection of hierarchy objects may be performed in relation to hierarchy member selections.

In one embodiment, a user may create a document on top of a universe X. A query may be created and hierarchy object A may be selected. Together with the selected hierarchy object A, a measure from the universe objects may also be selected and added in the query panel in relation to generating a result object. A hierarchy member selection may be created on the selected hierarchy object A. The selection of a hierarchy member may be performed through a member selector tool, where available members may be selected in set expressions. The query may be run and hierarchy properties of the hierarchy may be included. The hierarchy properties may correspond to the described hierarchy Properties 435, FIGS. 4 and 535. FIG. 5. A request including the query may be send to the DB and a data set may be retrieved including the hierarchical data. The created document may be saved and published in a repository, such as the repository where the universe is stored. The document may be saves with hierarchy metadata and hierarchical data set retrieved at query runtime. When a refresh operation is performed on the document, the hierarchy member selection values during the query time may be used again to refresh the document data.

FIGS. 6A, 6B, 6C, 6D, 6E, and 6F are block diagrams illustrating exemplary definitions of queries in a query pane, such as the query pane discussed above, and generated corresponding query results. Block 610, 625, 635, 645, 655, and 665 present exemplary query panes. Block 620, 630, 640, 650, 660, and 670 present exemplary query results generated when queries as defined in corresponding query panes am executed.

On FIG. 6A, a query is created in query panel 610, which is associated with a universe where a hierarchy object “Customer Geography” is defined. The hierarchy object “Customer Geography” may be such as the discussed hierarchy object “Customer Geography” 420 in relation to FIG. 4. The hierarchy object “Customer Geography” is selected as result object in query panel 610. A selection of hierarchy members from the hierarchy level values is performed in the query panel 610. The selection is defined for values “France”, “USA”, and “New York”. Another result object is defined to be “Net Sales”, where “Net Sales” is a measure object defined in the corresponding universe. The query result 620 that is generated represents a table, including a definition of the selected hierarchy level values in the left column, and correspondingly computed net sales values, invoked from the DB storing the data. Table 1 includes an exemplary generated SQL script in relation to the query in the query panel 610.

TABLE 1
(
SELECT

2 AS H1_{——}MEMBER_{——}DEPTH,
DIMCUSTOMER.COUNTRYNAME AS H1_{——}MEMBER_CAPTION,
DIMCUSTOMER.REGIONNAME AS H1_MEMBER_PARENT,
sum(FCTCUSTOMERORDER.NETSALES) AS “Net Sales”

FROM

DIMCUSTOMER INNER JOIN FCTCUSTOMERORDER ON

(DIMCUSTOMER.CUSTOMERID=FCTCUSTOMERORDER.CUSTOMERID)
WHERE

DIMCUSTOMER.COUNTRYNAME = ‘France’ /* select France for COUNTRY

level*/

OR
DIMCUSTOMER.COUNTRYNAME = ‘USA’ /* select USA for COUNTRY level */

GROUP BY

DIMCUSTOMER.COUNTRYNAME,
DIMCUSTOMER.REGIONNAME

UNION ALL
SELECT

3 AS H1_{——}MEMBER_DEPTH,
DIMCUSTOMER.CITYNAME AS H1_{——}MEMBER_CAPTION,
DIMCUSTOMER.COUNTRYNAME AS H1_MEMBER_PARENT,
sum(FCTCUSTOMERORDER.NETSALES) AS “Net Sales”

FROM

DIMCUSTOMER INNER JOIN FCTCUSTOMERORDER ON

(DIMCUSTOMER.CUSTOMERID=FCTCUSTOMERORDER.CUSTOMERID)
WHERE

DIMCUSTOMER.CITYNAME = ‘New York’ /* select New York for CITY level */

GROUP BY

DIMCUSTOMER.CITYNAME,
DIMCUSTOMER.COUNTRYNAME

)

FIGS. 6B, 6C, 6D, 6E, and 6F define queries similar to the described query in relation to FIG. 6A.

FIG. 6B provides an exemplary query defined in query panel 625, where a hierarchy member selection for “USA” is defined in relation to a hierarchy object “Customer Geography” and additional definition of a function based on the hierarchy objects is selected—“Children of USA”. The function is related to the hierarchy and inherent relationships, which is native to hierarchy level. A child of USA is a set of hierarchy members from a next lower level to the level corresponding to “USA”. If “USA” is of a level “Country”, then the “Children of USA” are hierarchy members at a hierarchy level “City” (when “City” is the next lower hierarchy level).

FIG. 6C provides an exemplary query in query pane 645, where a hierarchy member selection for “USA” is provided in relation to a hierarchy object “Customer Geography” and additional definition of a function based on the hierarchy objects is selected—“Descendants of USA”. The function is related to the hierarchy and inherent relationships, which is native to hierarchy level. A descendant of USA is a set of hierarchy members at all of the lower next level to the level corresponding to USA. If USA is of a level “Country”, then the “Descendants of USA” are hierarchy members at a hierarchy level “City” and hierarchy level “Customer” (when “City” and “Customer” are the next lower hierarchy level).

FIG. 6D provides an exemplary query in query pane 655, where a hierarchy member selection for “USA” is defined in relation to a hierarchy object “Customer Geography” and additional definition of a function based on the hierarchy objects is selected—“Ancestors of USA”. The function is related to the hierarchy and inherent relationships, which is native to hierarchy level. An ancestor of USA is a set of hierarchy members defined at higher level to the level corresponding to USA. If USA is of a level “Country”, then the “Ancestors of USA” are hierarchy members defined at a hierarchy level “Region” (when the hierarchy is such as Region>Country>City>Customer).

FIG. 6E provides an exemplary query in query pane 655, where a hierarchy member selection for “USA” is defined in relation to a hierarchy object “Customer Geography” and additional definition of a function based on the hierarchy objects is selected—“Parent of USA”. The function is related to the hierarchy and inherent relationships, which is native to hierarchy level. A parent of USA is a hierarchy member from a higher level to the level corresponding to USA, which is in direct connection to “USA”. If USA is of a level “Country”, then the “Parent of USA” is an hierarchy member defined at a hierarchy level “Region”, which is connected to USA, which is “North America” (when the hierarchy is such as Region>Country>City>Customer, and “North America” is the hierarchy member connected to USA).

FIG. 6F provides an exemplary query in query pane 665, where a definition of functions based on the hierarchy objects is provided—“Children of North America”, “Descendants of USA”, and not “Descendants of Washington”. Based on the functions and associated conditions for interpreting the hierarchy members relations, a set of hierarchy members may be defined and a corresponding net sales values may be determined.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

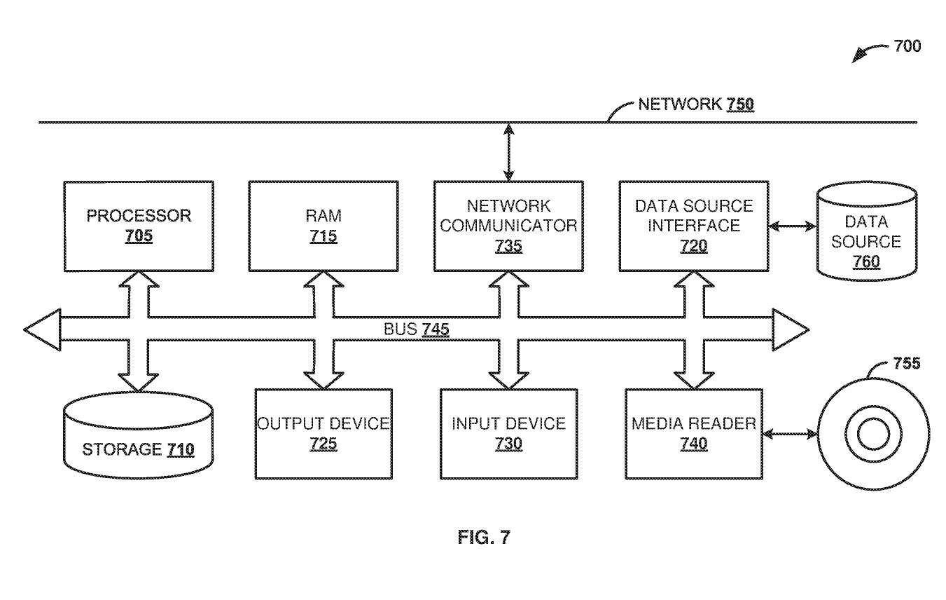

FIG. 7 is a block diagram of an exemplary computer system 700. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, all of the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope of the one or more embodiments, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to support hierarchy member selections in queries based on relational databases, the method comprising:
creating a universe on top of a relational database, wherein the universe includes objects of different types, wherein the relational database includes hierarchical data;
creating a hierarchy object in the universe, wherein the hierarchy object defines a hierarchy of objects defined as dimensions in the universe; and
publishing the universe in a repository to execute hierarchical queries, wherein the universe includes the hierarchy object.

2. The method of claim 1, wherein the different types of objects include dimensions and measures.

3. The method of claim 1, wherein creating the hierarchy object further comprises:
determining a hierarchy type for the hierarchy object, wherein the hierarchy type is selected from the group consisting of f a level-based hierarchy type and a parent-child hierarchy type.

4. The method of claim 1, wherein creating the universe on top of the relational database further comprises:
creating a connection to the relational database to define a data foundation for creating the universe; and
defining a business object layer including the defined objects in the universe.

5. The method of claim 4, wherein the universe is created in the business object layer, and wherein creating the one or more hierarchy objects includes:
providing the universe to an information design tool;
creating a new hierarchy object in the business object layer;
defining a hierarchy type for the new hierarchy object in the information design tool; and
defining a set of objects defined as dimensions in the universe as hierarchy levels in the new hierarchy object.

6. The method of claim 1, further comprising:
receiving a request to provide the universe from the repository to an information design tool;
defining a query based on the universe to generate a report, wherein the report is defined in relation to the hierarchy object;
running the query in the relational database; and
retrieving a data set from the relational database.

7. The method of claim 6, wherein the defined query includes selection of hierarchy members from at least one hierarchy object created in the universe.

8. The method of claim 1, wherein publishing the universe in the repository includes saving the one or more hierarchy objects in the universe and exporting the universe into the repository.

9. A computer system to support hierarchy member selections in queries based on relational databases comprising:
a processor;
a memory in association with the processor storing instructions related to:
create a universe on top of a relational database, wherein the universe includes objects of different types, wherein the relational database includes hierarchical data;
create one or more hierarchy objects in the universe, wherein an hierarchy object defines a hierarchy of objects defined as dimensions in the universe; and
publishing the universe in a repository to execute hierarchical queries, wherein the universe includes the one or more hierarchy objects.

10. The system of claim 9, wherein the different types of objects include dimensions and measures, wherein a first hierarchy object from the one or more hierarchy objects is of a level-based hierarchy type, and wherein a second hierarchy object from the one or more hierarchy objects is of a parent-child hierarchy type.

11. The system of claim 9, wherein the instructions to create the universe on top of the relational database further comprises instructions to:
create a connection to the relational database to define a data foundation for creating the universe; and
define a business object layer including the defined objects in the universe.

12. The system of claim 11, wherein the universe is created in the business object layer, and wherein the instructions to create the one or more hierarchy objects further include instructions to:
provide the universe to an information design tool;
create a new hierarchy object in the business object layer;
define a hierarchy type for the new hierarchy object in the information design tool; and
define a set of objects defined as dimensions in the universe as hierarchy levels in the new hierarchy object.

13. The system of claim 12, further comprising instructions to:
receive a request to provide the universe from the repository to an information design tool;
define a query based on the universe to generate a report, wherein the report is defined in relation to the one or more hierarchy objects, wherein the query includes selection of hierarchy members from at least one hierarchy object created in the universe;
run the query in the relational database; and
retrieve a data set from the relational database.

14. The system of claim 9, wherein publishing the universe in the repository includes saving the one or more hierarchy objects in the universe and exporting the universe into the repository.

15. The system of claim 9, wherein the repository is a central management system including stored universes associated with database connections and generated reports based on the universes and the connections

16. A non-transitory computer-readable medium storing instructions, which when executed cause a computer system to:
create a universe on top of a relational database, wherein the universe includes objects of different types, wherein the relational database includes hierarchical data;
create one or more hierarchy objects in the universe, wherein an hierarchy object defines a hierarchy of objects defined as dimensions in the universe; and
publishing the universe in a repository to execute hierarchical queries, wherein the universe includes the one or more hierarchy objects.

17. The computer-readable medium of claim 16, wherein the different types of objects include dimensions and measures, wherein a first hierarchy object from the one or more hierarchy objects is of a level-based hierarchy type, and wherein a second hierarchy object from the one or more hierarchy objects is of a parent-child hierarchy type.

18. The computer-readable medium of claim 16, wherein the instructions to create the universe on top of the relational database further comprises instructions to:
create a connection to the relational database to define a data foundation for creating the universe;
define a business object layer including the defined objects in the universe;
providing the universe to an information design tool;
create a new hierarchy object in the business object layer;
define a hierarchy type for the new hierarchy object in the information design tool; and
define a set of objects defined as dimensions in the universe as hierarchy levels in the new hierarchy object.

19. The computer-readable medium of claim 18, further comprising instructions to:
receive a request to provide the universe from the repository to an information design tool;
define a query based on the universe to generate a report, wherein the report is defined in relation to the one or more hierarchy objects, wherein the query includes selection of hierarchy members from at least one hierarchy object created in the universe;
run the query in the relational database; and
retrieve a data set from the relational database.

20. The computer-readable medium of claim 18, wherein publishing the universe in the repository includes saving the one or more hierarchy objects in the universe and exporting the universe into the repository.
